(19) United States
(12) Patent Application Publication
(10) Pub. No.: US 2020/0394380 A1
(43) Pub. Date: Dec. 17, 2020

(54) OPTICAL FINGERPRINT SENSING DEVICE AND OPERATION METHOD THEREOF

(71) Applicant: Novatek Microelectronics Corp., Hsinchu (TW)

(72) Inventors: Yi-Ting Chung, Hsinchu County (TW); Hsing-Lung Chung, Miaoli County (TW); Che-Yu Lin, Hsinchu City (TW)

(73) Assignee: Novatek Microelectronics Corp., Hsinchu (TW)

(21) Appl. No.: 16/438,504

(22) Filed: Jun. 12, 2019

(51) Int. Cl. G06K 9/00; G06F 3/041

(52) U.S. Cl. CPC G06K 9/00013; G06F 3/0416; G06K 9/00067

(57) ABSTRACT

An optical fingerprint sensing device and an operation method thereof are provided. The optical fingerprint sensing device includes an optical fingerprint sensing circuit and a control circuit. The control circuit is coupled to the optical fingerprint sensing circuit. The control circuit is configured to dynamically adjust at least one operation parameter of the optical fingerprint sensing circuit in accordance with environment information. The optical fingerprint sensing circuit is configured to capture a fingerprint image according to the at least one operation parameter.

### BACKGROUND

### Field of the Invention

The invention relates to a fingerprint sensing device and more particularly, to an optical fingerprint sensing device and an operation method thereof.

### Description of Related Art

In recent years, demands for fingerprint sensing have been gradually increased. In order to reduce a volume of an electronic device, a fingerprint sensing region may be disposed in a display region of a display panel. For example, an under-display fingerprint recognition technique is to dispose/attach a fingerprint sensor beneath (on a back surface of) the display panel. When a finger touches the display panel, a fingerprint sensor may sense/capture a fingerprint image of the finger through the display panel. Due to the restriction in a transmittance capability of a capacitive sensor, the under-display fingerprint recognition technique adopts an optical imaging or optical sensing technique.

Based on a design requirement for further reducing a thickness of the display device, an in-display fingerprint recognition technique has been accordingly developed. Different from the under-display fingerprint recognition technique, the in-display fingerprint recognition technique is to embed a fingerprint sensor array in the display panel. Namely, the display panel with the in-display fingerprint recognition function has a pixel circuit array and an in-display fingerprint sensor array.

However, a conventional optical fingerprint recognition sensor commonly captures the fingerprint image according to specific (fixed) operation parameters, instead of adaptively adjusting the operation parameters in accordance with various actual use environments, which results in non-optimal quality of the fingerprint image, reduction in a success rate of the fingerprint recognition and unpleasant experience to users. For example, in a situation with intensive environment light, the fingerprint image captured by the conventional optical fingerprint recognition sensor may likely have an issue of overexposure. In addition, not only the environment issue, a light source (e.g., an organic light-emitting diode (OLED) display panel) used to capture the image may encounter an issue of brightness decay. In different actual use environments, if the conventional optical fingerprint recognition sensor captures the fingerprint image by using the specific (fixed) operation parameters, the quality of the captured fingerprint image may be likely unbearable to be used.

It should be noted that the contents of the section of “Description of Related Art” is used for facilitating the understanding of the invention. A part of the contents (or all of the contents) disclosed in the section of “Description of Related Art” may not pertain to the conventional technology known to the persons with ordinary skilled in the art. The contents disclosed in the section of “Description of Related Art” do not represent that the contents have been known to the persons with ordinary skilled in the art prior to the filing of this invention application.

### SUMMARY

The invention provides an optical fingerprint sensing device and an operation method thereof capable of being adapted to an environment to dynamically adjust operation parameters of an optical fingerprint sensing circuit.

According to an embodiment of the invention, an optical fingerprint sensing device is provided. The optical fingerprint sensing device includes an optical fingerprint sensing circuit and a control circuit. The optical fingerprint sensing circuit is configured to capture a fingerprint image of the fingerprint. The control circuit is coupled to the optical fingerprint sensing circuit. The control circuit is configured to dynamically adjust at least one operation parameter of the optical fingerprint sensing circuit in accordance with environment information. The optical fingerprint sensing circuit captures the fingerprint image according to the at least one operation parameter.

According to an embodiment of the invention, an operation method of an optical fingerprint sensing device is provided. The operation method includes: dynamically adjusting at least one operation parameter of the optical fingerprint sensing circuit according to environment information; and capturing a fingerprint image according to the at least one operation parameter by the optical fingerprint sensing circuit.

To sum up, the optical fingerprint sensing device and the operation method thereof provided by the embodiments of the invention can obtain the environment information associated with the optical fingerprint sensing circuit and/or sensors. According to the environment information, the control circuit can dynamically adjust the at least one operation parameter of the optical fingerprint sensing circuit. Therefore, the optical fingerprint sensing device can be adapted to the environment to dynamically adjust the operation parameters of the optical fingerprint sensing circuit, so as to optimize the quality of the captured fingerprint image.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit block diagram illustrating an optical fingerprint sensing device according to an embodiment of the invention.

FIG. 2 is a flowchart illustrating an operation method of an optical fingerprint sensing device according to an embodiment of the invention.

FIG. 3 is a schematic circuit block diagram illustrating an optical fingerprint sensing device according to another embodiment of the invention.

FIG. 4 is a flowchart illustrating an operation method of an optical fingerprint sensing device according to yet another embodiment of the invention.

FIG. 5 is a flowchart illustrating an operation method of an optical fingerprint sensing device according to still another embodiment of the invention.

### DESCRIPTION OF EMBODIMENTS

The term “couple (or connect)” throughout the specification (including the claims) of this application are used broadly and encompass direct and indirect connection or coupling means. For example, if the disclosure describes a first device being coupled (or connected) to a second device, then it should be interpreted that the first device can be directly connected to the second device, or the first device can be indirectly connected to the second device through other devices or by a certain coupling means. In addition, terms such as “first” and “second” mentioned throughout the specification (including the claims) of this application are only for naming the names of the elements or distinguishing different embodiments or scopes and are not intended to limit the upper limit or the lower limit of the number of the elements not intended to limit sequences of the elements. Moreover, elements/components/steps with same reference numerals represent same or similar parts in the drawings and embodiments. Elements/components/notations with the same reference numerals in different embodiments may be referenced to the related description.

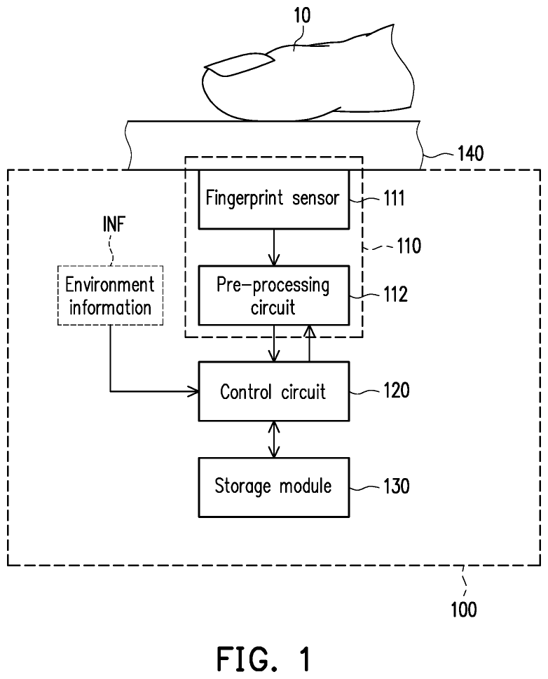

FIG. 1 is a schematic circuit block diagram illustrating an optical fingerprint sensing device 100 according to an embodiment of the invention. The optical fingerprint sensing device 100 includes an optical fingerprint sensing circuit 110, and a control circuit 120. Based on a design requirement, the panel 140 illustrated in FIG. 1 may be a thin panel made of a light transparent material (e.g., glass or plastic). When a user's finger 10 presses on the panel 140 of the optical fingerprint sensing device 100, the optical fingerprint sensing circuit 110 may capture a fingerprint image of the finger 10.

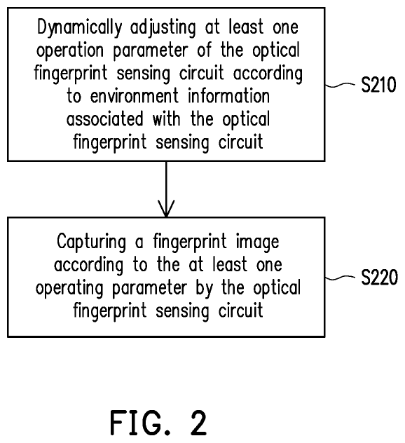

FIG. 2 is a flowchart illustrating an operation method of an optical fingerprint sensing device according to an embodiment of the invention. Referring to FIG. 1 and FIG. 2, the control circuit 120 is coupled to the optical fingerprint sensing circuit 110. In accordance with environment information INF, the control circuit 120 may, in step S210, dynamically adjust at least one operation parameter of the optical fingerprint sensing circuit 110. In step S210, the optical fingerprint sensing circuit 110 may capture the fingerprint image of the finger 10 according to the at least one operation parameter.

For example, in the embodiment illustrated in FIG. 1, the optical fingerprint sensing device 110 includes a fingerprint sensor 111 and a pre-processing circuit 112. The fingerprint sensor 111 may capture an original fingerprint image of the finger 10 and transmit the original fingerprint image to the pre-processing circuit 112. The implementation manner of the fingerprint sensor 111 is not limited in the present embodiment. Based on a design requirement, the fingerprint sensor 111 may be a conventional fingerprint sensor or any other optical fingerprint sensor. Based on a design requirement, the fingerprint sensor 111 may be an under-display fingerprint recognition type sensor, or an in-display fingerprint recognition type sensor.

According to the operation parameter dynamically set by the control circuit 120, the pre-processing circuit 112 may perform image pre-processing (e.g., image correction) on the original fingerprint image provided by the fingerprint sensor 111 and output an pre-processed image (i.e., the fingerprint image of the finger 10) to the control circuit 120. The implementation manner of the pre-processing circuit 112 is not limited in the present embodiment. Based on a design requirement, the pre-processing circuit 112 may be a conventional image preprocessing circuit or any other fingerprint image preprocessing circuit. According to the environment information INF associated with the optical fingerprint sensing circuit 110, the control circuit 120 may dynamically adjust at least one operation parameter of the pre-processing circuit 112. By adaptively adjusting the operation parameter, the quality of fingerprint image captured by the optical fingerprint sensing circuit 110 may be optimized by the control circuit 120.

After obtaining the fingerprint image, the control circuit 120 may perform post processing (e.g., fingerprint feature capturing), fingerprint registration and/or fingerprint recognition (e.g., fingerprint matching) on the fingerprint image. For example, a storage module 130 may store a registered fingerprint, and the control circuit 120 may compare the fingerprint image with the registered fingerprint.

The implementation aspect of the environment information INF may be determined based on a design requirement. For example, in some embodiments, the environment information INF includes an environment light brightness of the optical fingerprint sensing circuit 110. When the finger 10 does not press on the panel 140, the control circuit 120 may sense the environment light brightness through the optical fingerprint sensing circuit 110 and serve the environment light brightness as the environment information INF. The control circuit 120 may dynamically adjust the operation parameter of the optical fingerprint sensing circuit 110 according to the environment light brightness. Based on a design requirement, the operation parameter may include at least one of a photosensitivity, a sensitivity and a denoise degree of the optical fingerprint sensing circuit 110.

When the environment light brightness is low (e.g., the environment light brightness is lower than a standard brightness), the fingerprint image captured by the optical fingerprint sensing circuit 110 may usually tend to be dark, and thus, the control circuit 120 may increase the photosensitivity of the optical fingerprint sensing circuit 110. For example, in some embodiments, the control circuit 120 may dynamically adjust the photosensitivity of the optical fingerprint sensing circuit 110 by adjusting an exposure time of the optical fingerprint sensing circuit 110. For example, the control circuit 120 may dynamically increase the photosensitivity by increasing the exposure time of the optical fingerprint sensing circuit 110. When the environment light brightness is high (e.g., the environment light brightness is higher than the standard brightness), the fingerprint image captured by the optical fingerprint sensing circuit 110 may usually be overexposed, and thus, the control circuit 120 may dynamically decrease the photosensitivity of the optical fingerprint sensing circuit 110 by reducing the exposure time of the optical fingerprint sensing circuit 110.

In some embodiments, the control circuit 120 may dynamically adjust the sensitivity of the optical fingerprint sensing circuit 110 by adjusting an analog gain of the optical fingerprint sensing circuit 110. For example, the control circuit 120 may dynamically increase the sensitivity by increasing the analog gain of the pre-processing circuit 112.

In some embodiments, the pre-processing circuit 112 of the optical fingerprint sensing circuit 110 may repeatedly capture n images of the fingerprint through the fingerprint sensor 111 (wherein n may be any integer determined based on a design requirement) and perform image superposition on the n images (or perform averaging on co-located pixels of the n images) to remove noise. The control circuit 120 may dynamically adjusts the denoise degree of the optical fingerprint sensing circuit 110 by adjusting the number of n of the n images. For example, the control circuit 120 may dynamically increase the denoise degree according to the number of n.

In some other embodiments, the environment information INF may include a signal-to-noise ratio (SNR) of the fingerprint image captured by the optical fingerprint sensing circuit 110. After obtaining the fingerprint image captured by the optical fingerprint sensing circuit 110, the control circuit 120 may calculate the SNR of the captured fingerprint image. The calculation details related to the SNR are not limited in the present embodiment. For example, based on a design requirement, the method that the control circuit 120 calculates the SNR may be a conventional SNR calculation method or other calculation methods. The control circuit 120 may obtain the SNR of the optical fingerprint sensing circuit 110 according to the fingerprint image captured by the optical fingerprint sensing circuit 110. According to the SNR, the control circuit 120 may dynamically adjust the operation parameter of the optical fingerprint sensing circuit 110. Based on a design requirement, the operation parameter may include at least one of a photosensitivity, a sensitivity and a denoise degree of the optical fingerprint sensing circuit 110. Regarding the photosensitivity, the sensitivity and the denoise degree of the example described in this paragraph, they may be inferred with reference to the description related to the previous example and will no longer be repeated.

Based on a design requirement, in some embodiments, the panel 140 may be a self-luminous display panel, for example, an organic light emitting diode (OLED) display panel. The self-luminous display panel may display an image. In addition, the self-luminous display panel may serve as a light source for the optical fingerprint sensing circuit 110 to capture the fingerprint image of the finger 10. In some embodiments, the environment information INF includes a light source brightness of the optical fingerprint sensing circuit 110. The control circuit 120 may sense the light source brightness of the light source (i.e., the panel 140) through the optical fingerprint sensing circuit 110. The control circuit 120 may dynamically adjust the operation parameter of the optical fingerprint sensing circuit 110 according to the light source brightness. Based on a design requirement, the operation parameter may include at least one of a photosensitivity, a sensitivity and a denoise degree of the optical fingerprint sensing circuit 110. Regarding the photosensitivity, the sensitivity and the denoise degree of the example described in this paragraph, they may be inferred with reference to the description related to the previous example and will no longer be repeated. Thus, when the brightness of the light source (i.e., the panel 140) decays, the control circuit 120 may dynamically adjust the operation parameter of the optical fingerprint sensing circuit 110, so as to optimize the quality of the captured fingerprint image.

Based on a design requirement, in some embodiments, the panel 140 may include a touch sensing panel. When a touch event occurs to the touch sensing panel (e.g., the finger presses the panel 140), the touch sensing panel may sense a touch position and a touch area of the touch event. In some embodiments, the environment information INF may include a press area ratio of the finger 10 to the optical fingerprint sensing circuit 110. The control circuit 120 may determine the press area ratio of the finger 10 to the optical fingerprint sensing circuit 110 according to the touch position and the touch area. The control circuit 120 may dynamically adjust the operation parameter of the optical fingerprint sensing circuit 110 according to the press area ratio. Based on a design requirement, the operation parameter may include the photosensitivity of the optical fingerprint sensing circuit 110. Regarding the photosensitivity of the example described in this paragraph, it may be inferred with reference to the description related to the previous example and will no longer be repeated.

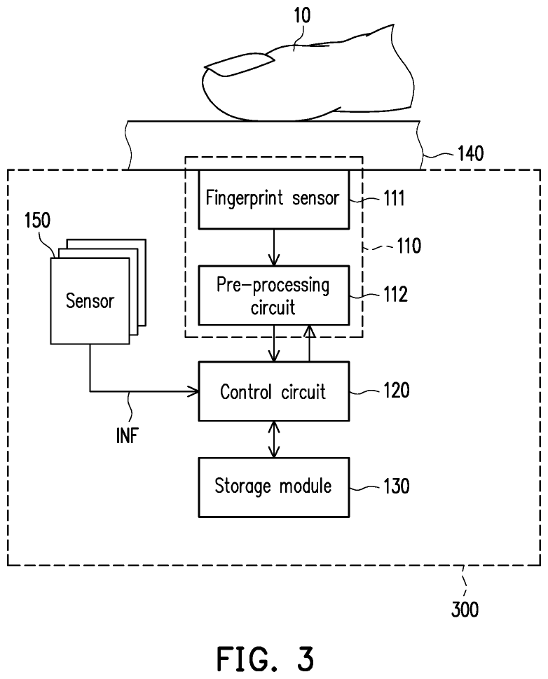

FIG. 3 is a schematic circuit block diagram illustrating an optical fingerprint sensing device 300 according to another embodiment of the invention. The optical fingerprint sensing device 300 includes an optical fingerprint sensing circuit 110, a control circuit 120, a storage module 130 and a sensor 150 (a sensor or sensors). The optical fingerprint sensing circuit 110, the control circuit 120, the storage module 130, the panel 140 and the environment information INF illustrated in FIG. 3 may be inferred with reference to the optical fingerprint sensing circuit 110, the control circuit 120, the storage module 130, the panel 140 and the environment information INF illustrated in FIG. 1 and will not be repeated.

Based on a design requirement, the sensor 150 may include one or more sensors. For example, in some embodiments, the sensor 150 may include a light sensor. The light sensor may sense an environment light brightness. In some embodiments, the environment information INF may include the environment light brightness of the optical fingerprint sensing circuit 110. The control circuit 120 may dynamically adjust the operation parameter of the optical fingerprint sensing circuit 110 according to the environment light brightness. Based on a design requirement, the operation parameter may include the photosensitivity and/or the sensitivity of the optical fingerprint sensing circuit 110. Regarding the photosensitivity and the sensitivity of the example described in this paragraph, they may be inferred with reference to the description related to the previous example and will no longer be repeated.

In some other embodiments, the sensor 150 may include a camera. The camera may capture an image. The control circuit 120 may determine the environment light brightness of the optical fingerprint sensing circuit 150 according to the image captured by the camera (the sensor 150), or determine the environment light brightness of the optical fingerprint sensing circuit 110 according to exposure corresponding to the camera. In some embodiments, the environment information INF includes the environment light brightness of the optical fingerprint sensing circuit 110. The control circuit 120 may dynamically adjust the operation parameter of the optical fingerprint sensing circuit 110 according to the environment light brightness. Based on a design requirement, the operation parameter may include the photosensitivity and/or the sensitivity of the optical fingerprint sensing circuit 110. Regarding the photosensitivity and the sensitivity of the example described in this paragraph, they may be inferred with reference to the description related to the previous example and will no longer be repeated.

In some other embodiments, the sensor 150 may include a temperature sensor. The temperature sensor may sense an environment temperature. In some embodiments, the environment information INF includes the environment temperature of the optical fingerprint sensing circuit 110. The control circuit 120 may dynamically adjust the operation parameter of the optical fingerprint sensing circuit 110 according to the environment temperature. Based on a design requirement, the operation parameter may include the photosensitivity and/or the denoise degree of the optical fingerprint sensing circuit 110. Regarding the photosensitivity and the denoise degree of the example described in this paragraph, they may be inferred with reference to the description related to the previous example and will no longer be repeated.

In yet other embodiments, the sensor 150 may include a humidity sensor. The humidity sensor may sense an environment humidity. In some embodiments, the environment information INF includes the environment humidity of the optical fingerprint sensing circuit 110. The control circuit 120 may dynamically adjust the operation parameter of the optical fingerprint sensing circuit 110 according to the environment humidity of the optical fingerprint sensing circuit 110. Based on a design requirement, the operation parameter may include at least one of the photosensitivity, the sensitivity and the denoise degree of the optical fingerprint sensing circuit 110. Regarding the photosensitivity, the sensitivity and the denoise degree of the example described in this paragraph, they may be inferred with reference to the description related to the previous example and will no longer be repeated.

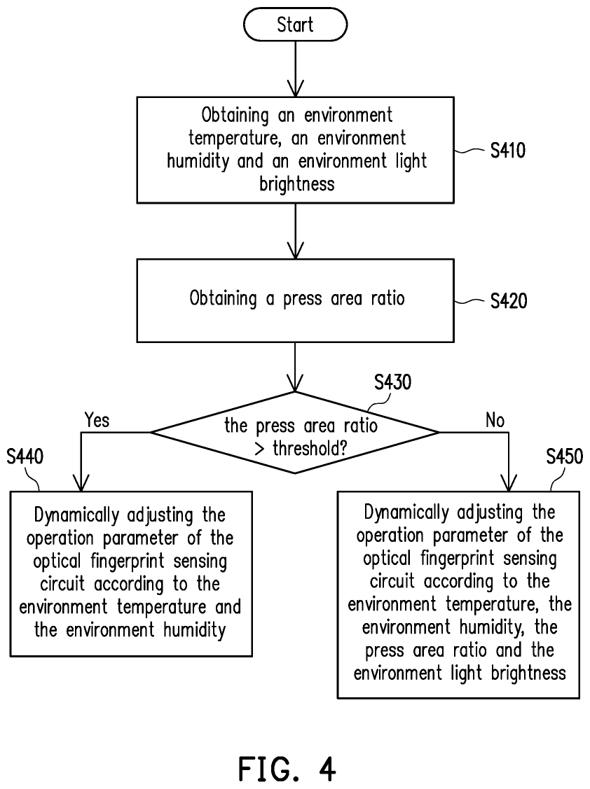

FIG. 4 is a flowchart illustrating an operation method of an optical fingerprint sensing device according to yet another embodiment of the invention. Referring to FIG. 3 and FIG. 4, in step S410, the control circuit 120 may sense the environment temperature through the temperature sensor (i.e., the sensor 150), sense the environment humidity through humidity sensor (i.e., the sensor 150) and sense the environment light brightness through the light sensor (i.e., the sensor 150). In step S420, the control circuit 120 may determine the press area ratio of the finger 10 to the optical fingerprint sensing circuit 110 according to the touch position and the touch area sensed by the touch sensing panel (i.e., the panel 140).

According to the press area ratio of step S420, the control circuit 120 may, in step S430, determine whether the press area ratio is greater than a threshold. When the press area ratio is greater than the threshold (i.e., the determination result of step S430 is “Yes”), the control circuit 120 may dynamically adjust the operation parameter of the optical fingerprint sensing circuit 110 according to the environment temperature and the environment humidity obtained in step S410 (step S440). Based on a design requirement, the operation parameter may include the photosensitivity or other parameters of the optical fingerprint sensing circuit 110. In some embodiments, the control circuit 120 may dynamically adjust the photosensitivity of the optical fingerprint sensing circuit 110 by adjusting the exposure time of the optical fingerprint sensing circuit 110. The control circuit 120 may control the pre-processing circuit 112 according to the environment temperature and the environment humidity of the optical fingerprint sensing circuit 110, so as to dynamically adjust the exposure time of the fingerprint sensor 111. For example, the control circuit 120 may, in step S440, determine the exposure time of the fingerprint sensor 111 according to Table 1 below.

TABLE 1
Exposure time (ms) of the optical fingerprint sensing circuit 110

| | <0° | 0-10° | 10-20° | 20-30° |
|---|---|---|---|---|
| Environment temperature | C. | C. | C. | C. |
| Environment humidity >50% | 17 | 19 | 17 | 15 |
| Environment humidity ≤50% | 24 | 22 | 20 | 17 |

When the press area ratio is not greater than a threshold (i.e., the determination result of step S430 is “No”), the control circuit 120 may dynamically adjust the operation parameter of the optical fingerprint sensing circuit 110 according to the environment temperature, the environment humidity and the environment light brightness obtained in step S410 and the press area ratio obtained in step S420 (step S450). Based on a design requirement, the operation parameter may include the photosensitivity or other parameters of the optical fingerprint sensing circuit 110. In some embodiments, the control circuit 120 may dynamically adjust the photosensitivity of the optical fingerprint sensing circuit 110 by adjusting the exposure time of the optical fingerprint sensing circuit 110. The control circuit 120 may control the pre-processing circuit 112 according to the environment temperature, the environment humidity, the environment light brightness and the press area ratio of the optical fingerprint sensing circuit 110, so as to dynamically adjust the exposure time of the fingerprint sensor 111. For example, the control circuit 120 may, in step S450, determine the exposure time of the fingerprint sensor 111 according to Table 2, Table 3 and Table 4 below.

TABLE 2
Exposure time (ms) of the optical fingerprint sensing circuit
110 in a condition that the press area ratio is from 2/3 to 1

| Environment temperature | <0° C. | | 0-10° C. | | 10-20° C. | | 20-30° C. | |
|---|---|---|---|---|---|---|---|---|
| Environment humidity | >50 | ≤50 | >50 | ≤50 | >50 | ≤50 | >50 | ≤50 |
| Brightness >100 KLux | 17 | 17 | 15 | 15 | 13 | 13 | 10 | 10 |
| Brightness: 70-100 KLux | 17 | 24 | 19 | 22 | 17 | 20 | 15 | 17 |
| Brightness: 30-70 KLux | 24 | 24 | 26 | 22 | 20 | 20 | 17 | 17 |
| Brightness: <30 KLux | 33 | 33 | 30 | 30 | 28 | 28 | 25 | 25 |

TABLE 3
Exposure time (ms) of the optical fingerprint sensing circuit
110 in a condition that the press area ratio is from 1/2 to 2/3

| Environment temperature | <0° C. | | 0-10° C. | | 10-20° C. | | 20-30° C. | |
|---|---|---|---|---|---|---|---|---|
| Environment humidity | >50 | ≤50 | >50 | ≤50 | >50 | ≤50 | >50 | ≤50 |
| Brightness >100 KLux | 10 | 10 | 8 | 8 | 7 | 7 | 7 | 7 |
| Brightness: 70-100 KLux | 10 | 17 | 8 | 15 | 7 | 13 | 7 | 13 |
| Brightness: 30-70 KLux | 17 | 17 | 15 | 15 | 13 | 13 | 13 | 13 |
| Brightness: <30 KLux | 17 | 17 | 15 | 15 | 13 | 13 | 13 | 13 |

TABLE 4
Exposure time (ms) of the optical fingerprint sensing circuit
110 in a condition that the press area ratio is from 0 to 1/2

| Environment temperature | <0° C. | | 0-10° C. | | 10-20° C. | | 20-30° C. | |
|---|---|---|---|---|---|---|---|---|
| Environment humidity | >50 | ≤50 | >50 | ≤50 | >50 | ≤50 | >50 | ≤50 |
| Brightness >100 KLux | 7 | 7 | 6 | 6 | 6 | 6 | 5 | 5 |
| Brightness: 70-100 KLux | 7 | 7 | 6 | 6 | 6 | 6 | 5 | 5 |
| Brightness: 30-70 KLux | 10 | 10 | 8 | 8 | 8 | 8 | 7 | 7 |
| Brightness: <30 KLux | 12 | 12 | 12 | 12 | 12 | 12 | 12 | 2 |

In other embodiments, the control circuit 120 may dynamically adjust the operation parameter of the optical fingerprint sensing circuit 110 according to the press area ratio and the environment light brightness. Based on a design requirement, the operation parameter may include the photosensitivity or other parameters of the optical fingerprint sensing circuit 110. In some embodiments, the control circuit 120 may dynamically adjust the photosensitivity of the optical fingerprint sensing circuit 110 by adjusting the exposure time of the optical fingerprint sensing circuit 110. The control circuit 120 may control the pre-processing circuit 112 according to the press area ratio and the environment light brightness, so as to dynamically adjust the exposure time of the fingerprint sensor 111. For example, the control circuit 120 may determine the exposure time of the fingerprint sensor 111 according to Table 5 below.

TABLE 5
Exposure time (ms) of the optical fingerprint sensing circuit 110

| | Ambient light brightness | Exposure |
|---|---|---|
| Press area ratio | (levels 1 to 10) | time |
| 2/3 to 1 | 8-10 | 25 |
| | 1-7 | 33 |
| 1/2 to 2/3 | 7-10 | 17 |
| | 4-6 | 25 |
| | 1-3 | 33 |
| 0 to 1/2 | 7-10 | 10 |
| | 4-6 | 20 |
| | 1-3 | 33 |

In other embodiments, the control circuit 120 may dynamically adjust the operation parameter of the optical fingerprint sensing circuit 110 according to the press area ratio, the environment light brightness and the environment temperature. Based on a design requirement, the operation parameter may include the photosensitivity and the denoise degree of the optical fingerprint sensing circuit 110. In some embodiments, the control circuit 120 may dynamically adjust the photosensitivity of the optical fingerprint sensing circuit 110 by adjusting the exposure time of the optical fingerprint sensing circuit 110. The pre-processing circuit 112 may repeatedly capture n images of the fingerprint through the fingerprint sensor 111 and perform the image superposition on the n images to remove noise. The control circuit 120 may dynamically adjust the denoise degree of the optical fingerprint sensing circuit 110 by adjusting the number of n of the n images. The control circuit 120 may control the pre-processing circuit 112 according to the press area ratio, the environment light brightness and the environment temperature, so as to dynamically adjust the exposure time and the number of n of the images of the fingerprint sensor 111. For example, the control circuit 120 may determine the exposure time and the number of n (it is assumed herein that n is a standard number) of the images of the fingerprint sensor 111 according to Table 6, Table 7 and Table 8 below.

TABLE 6
Exposure time (ms) and the number of n of images of the
optical fingerprint sensing circuit 110 in a condition
that the environment temperature is less than 5° C.

| | Ambient light brightness | Exposure | Number |
|---|---|---|---|
| Press area ratio | (levels 1 to 10) | time | of images |
| 2/3 to 1 | 8-10 | 25 | n + 2 |
| | 1-7 | 25 | n + 2 |
| 1/2 to 2/3 | 7-10 | 20 | n + 2 |
| | 4-6 | 27 | n + 2 |
| | 1-3 | 33 | n + 2 |
| 0 to 1/2 | 7-10 | 12 | n + 2 |
| | 4-6 | 22 | n + 2 |
| | 1-3 | 33 | n + 2 |

TABLE 7
Exposure time (ms) and the number of n of images of
the optical fingerprint sensing circuit 110 in a condition
that the environment temperature is 5-25° C.

| | Ambient light brightness | Exposure | Number |
|---|---|---|---|
| Press area ratio | (levels 1 to 10) | time | of images |
| 2/3 to 1 | 8-10 | 25 | n + 0 |
| | 1-7 | 33 | n + 0 |
| 1/2 to 2/3 | 7-10 | 17 | n + 0 |
| | 4-6 | 25 | n + 0 |
| | 1-3 | 33 | n + 0 |
| 0 to 1/2 | 7-10 | 10 | n + 0 |
| | 4-6 | 20 | n + 0 |
| | 1-3 | 33 | n + 0 |

TABLE 8
Exposure time (ms) and the number of n of images of the
optical fingerprint sensing circuit 110 in a condition
that the environment temperature is greater than 25° C.

| | Ambient light brightness | Exposure | Number |
|---|---|---|---|
| Press area ratio | (levels 1 to 10) | time | of images |
| 2/3 to 1 | 8-10 | 25 | n − 1 |
| | 1-7 | 33 | n − 1 |
| 1/2 to 2/3 | 7-10 | 17 | n − 1 |
| | 4-6 | 25 | n − 1 |
| | 1-3 | 33 | n − 1 |
| 0 to 1/2 | 7-10 | 10 | n − 1 |
| | 4-6 | 20 | n − 1 |
| | 1-3 | 33 | n − 1 |

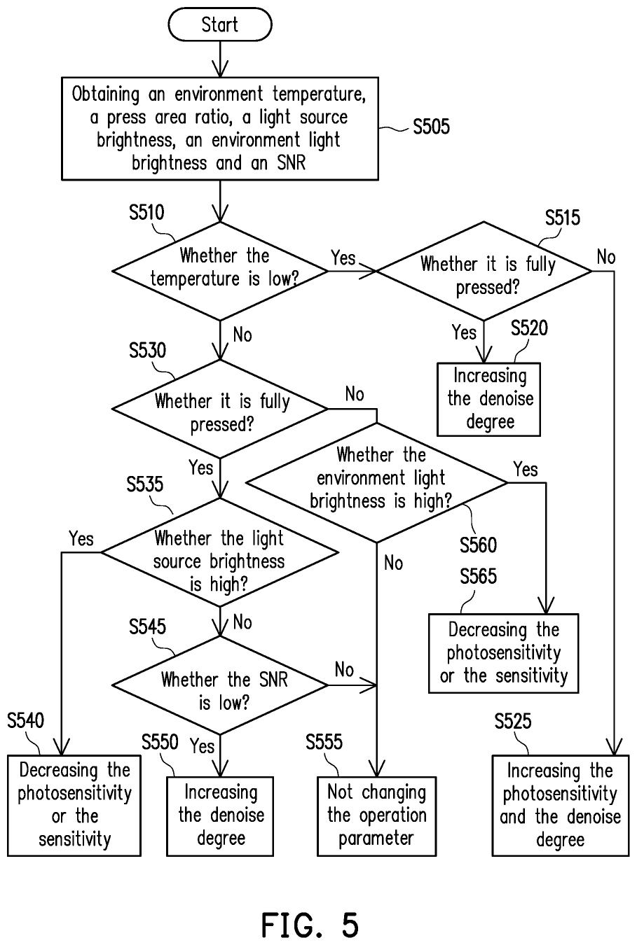

FIG. 5 is a flowchart illustrating an operation method of an optical fingerprint sensing device according to still another embodiment of the invention. Referring to FIG. 3 and FIG. 5, in step S505, the control circuit 120 may sense the environment temperature of the optical fingerprint sensing circuit 110 through the temperature sensor (i.e., the sensor 150), and sense the environment light brightness of the optical fingerprint sensing circuit 110 through the light sensor (i.e., the sensor 150). The control circuit 120 may, in step S505, further calculate a signal-to-noise ratio (SNR) of the fingerprint image captured by the optical fingerprint sensing circuit 110. In the present embodiment, the self-luminous display panel (i.e., the panel 140) may serve as the light source for capturing the fingerprint image, and the control circuit 120 may, in step S505, sense the light source brightness of the light source (i.e., the panel 140) through the optical fingerprint sensing circuit 110. In step S505, the control circuit 120 may further determine the press area ratio of the finger 10 to the optical fingerprint sensing circuit 110 according to the touch position and the touch area sensed by the touch sensing panel (i.e., the panel 140).

According to the environment temperature of step S505, the control circuit 120 may, in step 510, determine whether the environment temperature is low (e.g., determine whether the environment temperature is lower than a standard temperature). When the environment temperature is low (i.e., the determination result of step S510 is “Yes”), the control circuit 120 may perform step S515, so as to determine whether the finger 10 fully presses (fully covers) the fingerprint sensing region of the optical fingerprint sensing circuit 110. According to the press area ratio obtained in step S505, when the finger 10 fully presses (fully covers) the fingerprint sensing region of the optical fingerprint sensing circuit 110 (i.e., the determination result of step S515 is “Yes”), the control circuit 120 may dynamically increase the denoise degree of the optical fingerprint sensing circuit 110 (step S520). When the finger 10 does not fully press (fully cover) the fingerprint sensing region of the optical fingerprint sensing circuit 110 (i.e., the determination result of step S515 is “No”), the control circuit 120 may dynamically increase the photosensitivity and the denoise degree of the optical fingerprint sensing circuit 110 (step S525).

When the environment temperature is high (i.e., the determination result of step S510 is “No”, for example, the environment temperature is higher than a standard temperature), the control circuit 120 may perform step S530 to determine whether the finger 10 fully presses (fully covers) the fingerprint sensing region of the optical fingerprint sensing circuit 110. According to the press area ratio obtained in step S505, when the finger 10 fully presses (fully covers) the fingerprint sensing region of the optical fingerprint sensing circuit 110 (i.e., the determination result of step S530 is “Yes”), the control circuit 120 may perform step S535 to determine whether the light source brightness of step S505 is high (e.g., determine whether the light source brightness is higher than the standard brightness). When the light source brightness is high (i.e., the determination result of step S535 is “Yes”), the control circuit 120 may dynamically decrease the photosensitivity or the sensitivity of the optical fingerprint sensing circuit 110 (step S540).

When the light source brightness is dark (i.e., the determination result of step S535 is “No”, and the light source brightness is lower than the standard brightness). The control circuit 120 may perform step S545, so as to determine whether the SNR of the optical fingerprint sensing circuit 110 is low (e.g., determine whether the SNR is lower than a standard value). When the SNR is low (i.e., the determination result of step S545 is “Yes”), the control circuit 120 may dynamically increase the denoise degree of the optical fingerprint sensing circuit 110 (step S550). When the SNR is high (i.e., the determination result of step S545 is “No”), the control circuit 120 may not adjust the operation parameter of the optical fingerprint sensing circuit 110 (step S555).

According to the press area ratio obtained in step S505, when the finger 10 does not fully press (fully cover) the fingerprint sensing region of the optical fingerprint sensing circuit 110 (i.e., the determination result of step S530 is “No”), the control circuit 120 may perform step S560 to determine the environment light brightness of step S505 is high (e.g., whether the environment light brightness is higher than the standard brightness). When the environment light brightness is high (i.e., the determination result of step S560 is “Yes”), the control circuit 120 may dynamically decrease the photosensitivity or the sensitivity of the optical fingerprint sensing circuit 110 (step S565). When the environment light brightness is low (i.e., the determination result of step S560 is “No”), the control circuit 120 may not change the operation parameter of the optical fingerprint sensing circuit 110 (step S555).

Based on different design demands, the block of the control circuit 120 may be implemented in a form of hardware, firmware, software (i.e., programs) or in a combination of many of the aforementioned three forms. In terms of the hardware form, the control circuit 120 may be implemented in a logic circuit on an integrated circuit. Related functions of the control circuit 120 may be implemented in a form of hardware by utilizing hardware description languages (e.g., Verilog HDL or VHDL) or other suitable programming languages. For example, the related functions of the control circuit 120 may be implemented by one or more controllers, a micro-controller, a microprocessor, an application-specific integrated circuit (ASIC), a digital signal processor (DSP), a field programmable gate array (FPGA) and/or various logic blocks, modules and circuits in other processing units.

In terms of the software form and/or the firmware form, the related functions of the control circuit 120 may be implemented as programming codes. For example, the control circuit 120 may be implemented by using general programming languages (e.g., C or C++) or other suitable programming languages. The programming codes may be recorded/stored in recording media. The aforementioned recording media include, for example, a read only memory (ROM), a storage device and/or a random access memory (RAM). Additionally, the programming codes may be accessed from the recording medium and executed by a computer, a central processing unit (CPU), a controller, a micro-controller or a microprocessor to accomplish the related functions. As for the recording medium, a non-transitory computer readable medium, such as a tape, a disk, a card, a semiconductor memory or a programming logic circuit, may be used. In addition, the programs may be provided to the computer (or the CPU) through any transmission medium (e.g., a communication network or radio waves). The communication network is, for example, the Internet, wired communication, wireless communication or other communication media.

In light of the foregoing, the optical fingerprint sensing device and the operation method thereof provided by the embodiments of the invention can obtain the environment information associated with the optical fingerprint sensing circuit and/or other sensors. The implementation aspect of the environment information INF may be determined based on a design requirement. For example, in some embodiments, the environment information can include the environment light brightness, the environment temperature, the environment humidity, the SNR, the light source brightness and the press area ratio of the optical fingerprint sensing circuit. The control circuit can dynamically adjust the at least one operation parameter of the optical fingerprint sensing circuit according to the environment information. Based on a design requirement, the operation parameter can include at least one of the photosensitivity, the sensitivity and the denoise degree of the optical fingerprint sensing circuit. Therefore, the optical fingerprint sensing device can be adapted to the environment to dynamically adjust the operation parameters of the optical fingerprint sensing circuit, so as to optimize the quality of the captured fingerprint image.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An optical fingerprint sensing device, comprising:
an optical fingerprint sensing circuit, configured to capture a fingerprint image; and
a control circuit, coupled to the optical fingerprint sensing circuit, and configured to dynamically adjust at least one operation parameter of the optical fingerprint sensing circuit in accordance with environment information,
wherein the optical fingerprint sensing circuit captures the fingerprint image according to the at least one operation parameter.

2. The optical fingerprint sensing device according to claim 1, wherein the environment information comprises an environment light brightness, the control circuit senses the environment light brightness, and the control circuit dynamically adjusts the at least one operation parameter of the optical fingerprint sensing circuit according to the environment light brightness.

3. The optical fingerprint sensing device according to claim 2, wherein the control circuit senses the environment light brightness through the optical fingerprint sensing circuit.

4. The optical fingerprint sensing device according to claim 2, further comprising:
a light sensor, configured to sense the environment light brightness of the optical fingerprint sensing device,
wherein the control circuit dynamically adjusts the at least one operation parameter of the optical fingerprint sensing circuit according to the environment light brightness.

5. The optical fingerprint sensing device according to claim 2, further comprising:
a camera, configured to capture an image,
wherein the control circuit determines the environment light brightness according to the image, and the control circuit dynamically adjusts the at least one operation parameter of the optical fingerprint sensing circuit according to the environment light brightness.

6. The optical fingerprint sensing device according to claim 2, further comprising:
a camera,
wherein the control circuit determines the environment light brightness according to exposure corresponding to the camera, and the control circuit dynamically adjusts the at least one operation parameter of the optical fingerprint sensing circuit according to the environment light brightness.

7. The optical fingerprint sensing device according to claim 1, wherein the environment information comprises a light source brightness, and the optical fingerprint sensing device further comprises:
a self-luminous display panel, configured to display an image,
wherein the self-luminous display panel serves as a light source for the optical fingerprint sensing circuit to capture the fingerprint image, the control circuit senses the light source brightness of the light source through the optical fingerprint sensing circuit, and the control circuit dynamically adjusts the at least one operation parameter of the optical fingerprint sensing circuit according to the light source brightness.

8. The optical fingerprint sensing device according to claim 1, wherein the environment information comprises a press area ratio of a finger, and the optical fingerprint sensing device further comprises:
a touch sensing panel, configured to sense a touch position and a touch area of a touch event,
wherein the control circuit determines the press area ratio according to the touch position and the touch area, and the control circuit dynamically adjusts the at least one operation parameter of the optical fingerprint sensing circuit according to the press area ratio.

9. The optical fingerprint sensing device according to claim 1, wherein the environment information comprises an environment temperature, and the optical fingerprint sensing device further comprises:
a temperature sensor, configured to sense the environment temperature,
wherein the control circuit dynamically adjusts the at least one operation parameter of the optical fingerprint sensing circuit according to the environment temperature.

10. The optical fingerprint sensing device according to claim 1, wherein the environment information comprises an environment humidity, and the optical fingerprint sensing device further comprises:
a humidity sensor, configured to sense the environment humidity,
wherein the control circuit dynamically adjusts the at least one operation parameter of the optical fingerprint sensing circuit according to the environment humidity.

11. The optical fingerprint sensing device according to claim 1, wherein the at least one operation parameter comprises at least one of a photosensitivity, a sensitivity and a denoise degree of the optical fingerprint sensing circuit.

12. The optical fingerprint sensing device according to claim 11, wherein the control circuit dynamically adjusts the photosensitivity by adjusting an exposure time of the optical fingerprint sensing circuit.

13. The optical fingerprint sensing device according to claim 11, wherein the control circuit dynamically adjusts the sensitivity by adjusting an analog gain of the optical fingerprint sensing circuit.

14. The optical fingerprint sensing device according to claim 11, wherein the optical fingerprint sensing circuit repeatedly captures n images of a fingerprint and performs image superposition on the n images to remove noise, wherein the control circuit dynamically adjusts the denoise degree by adjusting the number of n of the n images.

15. An operation method of an optical fingerprint sensing device, comprising:
dynamically adjusting at least one operation parameter of an optical fingerprint sensing circuit according to environment information; and
capturing a fingerprint image according to the at least one operation parameter by the optical fingerprint sensing circuit.

16. The operation method according to claim 15, wherein the environment information comprises an environment light brightness, and the operation of dynamically adjusting the at least one operation parameter of the optical fingerprint sensing circuit comprises:
sensing the environment light brightness; and
dynamically adjusting the at least one operation parameter of the optical fingerprint sensing circuit according to the environment light brightness.

17. The operation method according to claim 16, wherein the operation of sensing the environment light brightness comprises:
sensing the environment light brightness through the optical fingerprint sensing circuit.

18. The operation method according to claim 16, wherein the operation of sensing the environment light brightness comprises:
sensing the environment light brightness of the optical fingerprint sensing device by a light sensor.

19. The operation method according to claim 16, wherein the operation of sensing the environment light brightness comprises:
capturing an image by a camera; and
determining the environment light brightness according to the image.

20. The operation method according to claim 16, wherein the operation of sensing the environment light brightness comprises:
determining the environment light brightness according to exposure corresponding to a camera.

21. The operation method according to claim 15, wherein the environment information comprises a light source brightness, and the operation of dynamically adjusting the at least one operation parameter of the optical fingerprint sensing circuit comprises:
sensing the light source brightness of a light source through the optical fingerprint sensing circuit, wherein a self-luminous display panel of the optical fingerprint sensing device serves as the light source for capturing the fingerprint image by the optical fingerprint sensing circuit; and
dynamically adjusting the at least one operation parameter of the optical fingerprint sensing circuit according to the light source brightness.

22. The operation method according to claim 15, wherein the environment information comprises a press area ratio of a finger to the optical fingerprint sensing circuit, and the operation of dynamically adjusting the at least one operation parameter of the optical fingerprint sensing circuit comprises:
sensing a touch position and a touch area of a touch event by a touch sensing panel;
determining the press area ratio according to the touch position and the touch area; and
dynamically adjusting the at least one operation parameter of the optical fingerprint sensing circuit according to the press area ratio.

23. The operation method according to claim 15, wherein the environment information comprises an environment temperature, and the operation of dynamically adjusting the at least one operation parameter of the optical fingerprint sensing circuit comprises:
sensing the environment temperature by a temperature sensor; and
dynamically adjusting the at least one operation parameter of the optical fingerprint sensing circuit according to the environment temperature.

24. The operation method according to claim 15, wherein the environment information comprises an environment humidity, and the operation of dynamically adjusting the at least one operation parameter of the optical fingerprint sensing circuit comprises:
sensing the environment humidity by a humidity sensor; and
dynamically adjusting the at least one operation parameter of the optical fingerprint sensing circuit according to the environment humidity.

25. The operation method according to claim 15, wherein the at least one operation parameter comprises at least one of a photosensitivity, a sensitivity and a denoise degree of the optical fingerprint sensing circuit.

26. The operation method according to claim 25, wherein the operation of dynamically adjusting the at least one operation parameter of the optical fingerprint sensing circuit comprises:
dynamically adjusting the photosensitivity by adjusting an exposure time of the optical fingerprint sensing circuit.

27. The operation method according to claim 25, wherein the operation of dynamically adjusting the at least one operation parameter of the optical fingerprint sensing circuit comprises:
dynamically adjusting the sensitivity by adjusting an analog gain of the optical fingerprint sensing circuit.

28. The operation method according to claim 25, wherein the operation of dynamically adjusting the at least one operation parameter of the optical fingerprint sensing circuit comprises:
repeatedly capturing n images of a fingerprint and performing image superposition on the n images by the optical fingerprint sensing circuit to remove noise; and
dynamically adjusting the denoise degree by adjusting the number of n of the n images.
